(19) United States
(12) Patent Application Publication
(10) Pub. No.: US 2004/0119816 A1
(43) Pub. Date: Jun. 24, 2004

(54) Extreme sports video system

(76) Inventor: Michael Swain, Sarasota, FL (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/725,886

(22) Filed: Dec. 2, 2003

Related U.S. Application Data
(60) Provisional application No. 60/430,603, filed on Dec. 2, 2002.

(51) Int. Cl. H04N 7/18

(52) U.S. Cl. 348/61

(57) ABSTRACT

The present invention provides a video system for use in extreme sports videography, particularly skydiving. The video system includes a remote video head disposed on the headgear of a user in communication with a video camera disposed in a body pouch selectably attachable to the body of the user or an item being worn by the user. A remote video head extension cable is provided to connect between the remote video head and the video camera disposed in the camera body pouch whereby the video signal being captured by the remote video head is transmitted to the camera disposed in the camera body pouch for recording.

### RELATED APPLICATION

This application claims priority of U.S. Provisional Patent Application Serial No. 60/430,603 filed Dec. 2, 2002, which is incorporated herein by reference.

### FIELD OF THE INVENTION

The present invention relates to videography equipment and more particularly to hands-free video equipment that allows a user to control the video camera while performing some other activity that requires the use of the user's hands.

### BACKGROUND OF THE INVENTION

Extreme sports are dynamic, exciting and entertaining and refer to those sports occurring in an extreme environment where participants have to stifle their fears and harness the powerful forces of nature. Participants in such sports are required to push themselves to physical, mental and spiritual limits while performing such sports. The number of variables involved in performing such sports is highly unpredictable, which in most cases seems to fuel the excitement for the participants. One such extreme sport is skydiving.

Since the beginning of the sport of skydiving in the early 1950s parachutists have mounted cameras (C) and eye sights (E) on the top or sides of their helmets (H) for use in filming other skydivers in freefall (see FIG. 1). Positioning the camera on the helmet H is required in this high action sport because only the head is free to aim the camera C while the rest of the body, especially the arms and legs, is constantly in use to position the skydiver in freefall. However, such an arrangement of the video equipment in this manner presents several drawbacks.

First, there is the danger of injury or death due to the whiplash action during the opening of the parachute. The parachute attachment points are at the top of the shoulders of the user via a harness worn on the body. When the parachute is deployed at the end of a freefall, the skydiver decelerates within a few seconds from vertical speeds over 120 miles per hour to virtually zero under an open canopy. This action generates tremendous forces and tends to violently swing the skydiver's body from a horizontal to a vertical position relative to the earth causing a whiplash effect upon the head and neck of the skydiver. It is appreciated that the additional mass of the camera disposed on the skydiver's helmet increases the danger of whiplash injury (see FIG. 2). Such injuries can range from pulled muscles, to damaged vertebrae, and/or to death from a broken neck.

Other disadvantages to traditional methods of mounting video equipment on the helmet include potential entanglement of portions of the parachute with the camera during deployment; difficulty in using the camera controls or to monitor its functions while in use due to its mounted position; and the exposure of the camera to the elements which may cause damage or complete failure as a result of such exposure.

The present invention provides advantages over conventional video equipment used in high-action sports such as skydiving and makes the use of such equipment safer, more functional, and more convenient.

### SUMMARY OF THE INVENTION

The present invention provides a video system for use with headgear worn by the user.

The inventive video system includes a miniature remote video head disposed on a front portion of the headgear worn by the user. The remote video head is fastened to the user's headgear with a conventional fastening means and may be supported thereon via the use of a universal mounting bracket under certain conditions.

A camera body pouch is provided and is operative to receive a conventional video camera therein. The pouch preferably includes a plurality of fasteners for securing the pouch and camera to the body or an object being worn on the body of the user. The pouch is formed of materials operative to secure the video camera therein and protect it from exposure and the rigors of a high-action sport.

A cable is provided and connects between the remote video head and the video camera disposed in the camera body pouch. The cable is operative to transmit a video signal from the remote video head to the video camera for recording the action on a recordable media.

The camera body pouch includes built-in monitor and control features that allow for the user to easily and conveniently monitor and control the camera while participating in or videotaping an extreme sport.

### BRIEF DESCRIPTION OF THE DRAWINGS

A better understanding of the present invention will be had upon reference to the following detailed description when read in conjunction with the accompanying drawings in which like parts are given like reference numerals and wherein:

FIGS. 1 and 2 illustrate a conventional method and apparatus for videotaping an extreme sport activity;

FIG. 3 illustrates various components of the video system as according to the invention;

FIG. 4 illustrates components of the video system disposed on a headgear as according to the invention;

FIG. 5 illustrates a front view of the camera body pouch;

FIG. 6 illustrates a rear top view of the camera body pouch;

FIG. 7 illustrates a side view of the camera body pouch wherein the battery compartment for the remote video head is disposed; and

FIG. 8 illustrates a conventional video camera being disposed in the camera body pouch having remote control and audio/video cables disposed therein.

### DETAILED DESCRIPTION OF THE INVENTION

The present invention provides a video system that has advantages over conventional videography equipment used for capturing the action of an extreme sport on videotape. The invention allows the videographer to better control his or her own sport actions, be it skydiving or snow skiing; to enjoy more relaxed and productive mental attitude due to a higher safety environment; to have less stress and more enjoyment of the video process by having more control over equipment functions; and, most important of all, to avoid potential injury or death in the pursuit of his or her sport and photographic goals.

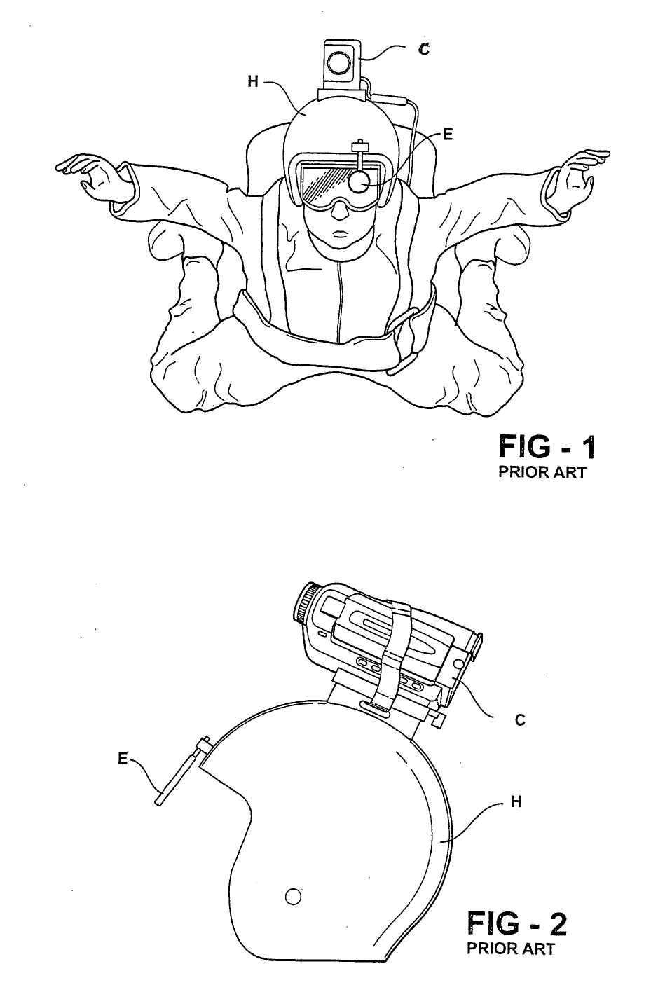

With reference to FIGS. 1 and 2, there is illustrated a conventional video system used for capturing on videotape an extreme sport such as skydiving. The conventional system includes a standard video camera or camcorder C disposed on the headgear H being worn by the user. The lens of the video camera C is in alignment with the user's line of sight to ensure that the lens of the camera is reliably capturing what the user is seeing. An eyesight ring E may be added to the system whereby the user knows that the lens of the video camera is capturing exactly what is seen through the eyesight ring E.

FIG. 2 illustrates a skydiving helmet with a video camera mounted on the top. Even though modern day video cameras are much lighter than the older movie cameras of the past, serious danger still exists from potential entanglement and whiplash injury during a skydiving episode.

The severity of a whiplash effect has a direct relationship to the mass of the camera that is attached to the helmet, multiplied by the distance from the base of the neck to the center of mass of the camera, multiplied by the velocity of motion. In practical terms, the maximum speed during a freefall while skydiving is usually a constant 120 miles per hour. Thus, it is appreciated that the larger the distance between the base of the user's neck and the center of mass of the camera, plus the larger the camera, the more likely the danger of whiplash injury when the user deploys the parachute.

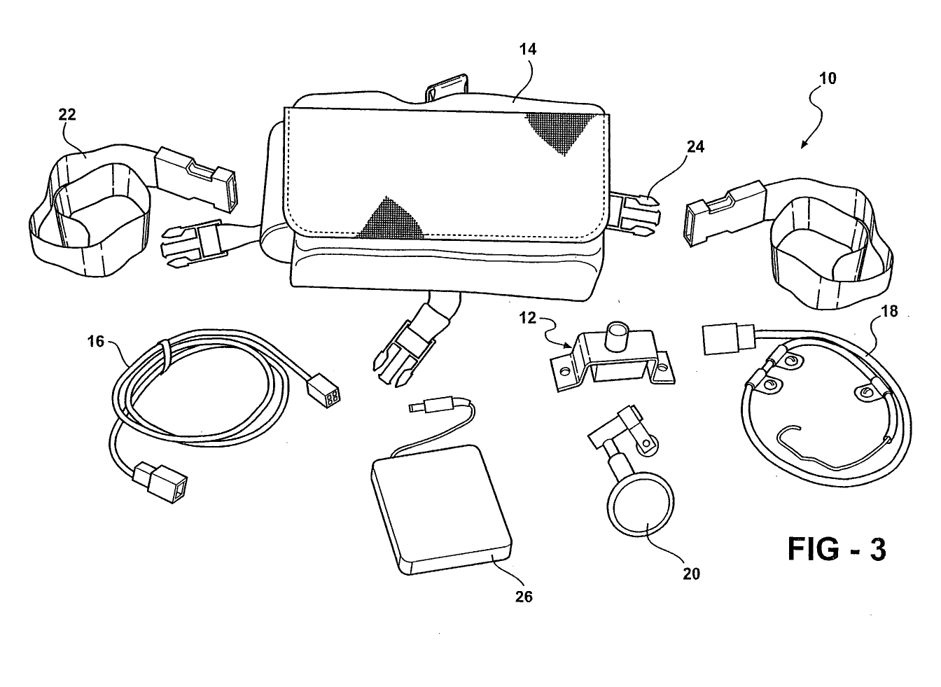

FIG. 3 illustrates the inventive video system 10 for use in videotaping extreme sports such as skydiving as according to the invention.

Essentially, the video system 10 includes a remote video head 12 (RVH), a camera body pouch 14 that is selectably attachable in front of the cameraperson's body below the waist when the video system 10 is used for skydiving, and an RVH extension cable 16 which is used to connect the RVH to a standard video camera disposed in the camera body pouch. Other components that optimize the utility of the video system 10 shown in FIG. 3 will be described hereinafter.

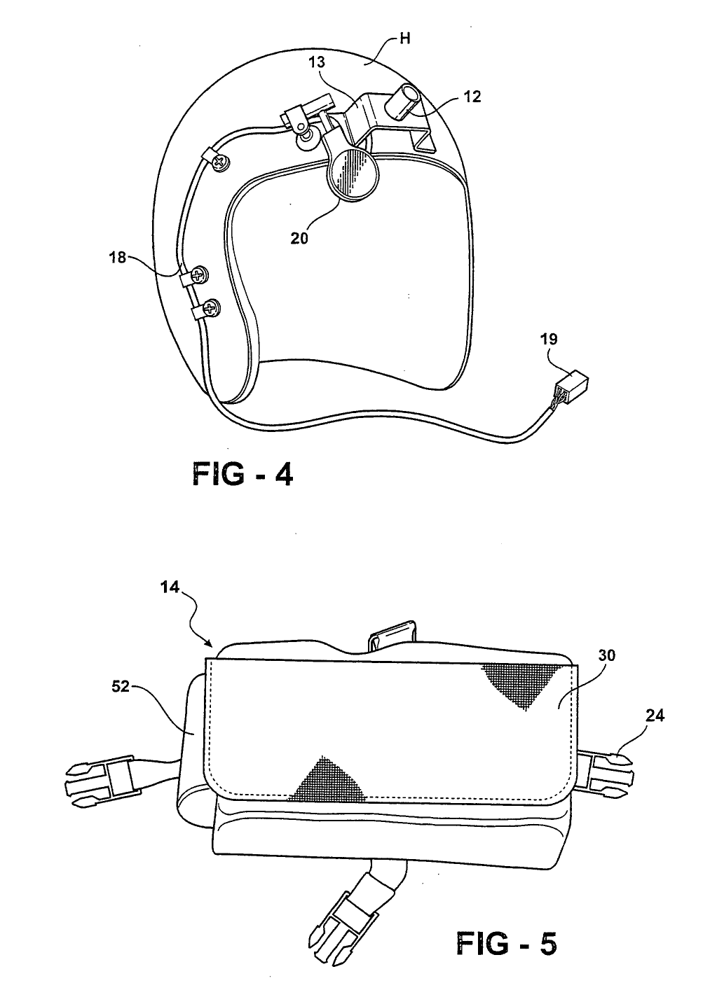

Referring now to FIG. 4, a skydiving helmet H is shown disposed with a remote video head 12 attached to a front portion thereof with the use of a universal mounting bracket 13. Preferably the RVH is a miniature color video camera. The RVH includes no tape transport, recording or playback functions. The RVH can be mounted to the user's headgear in a number of ways depending on the preference of the user. It can be fastened to the exterior of the helmet using conventional fastening means or attached to other items worn by the user such as safety goggles, other protective equipment, or clothing. In the preferred embodiment shown in FIG. 4, the RVH is exteriorly mounted to the headgear with a universal mounting bracket 13. The most important feature of the video system is the RVH due to its extremely small size and almost negligible weight which, by replacing the conventional helmet-mounted video camera, essentially eliminates the dangers of whiplash or entanglement drawbacks associated with the conventional videography equipment used in skydiving.

Also illustrated in FIG. 4 is an optional eyesight ring 20 which operates as an optical bulls-eye for the user to aim the lens of the RVH in the proper direction while recording. When the user has the subject lined up in the middle of the eyesight ring 20, the camera will be aligned to properly videotape the action. Preferably, the eyesight ring 20 is pivotally mounted to the helmet H such that the user may conveniently maneuver it into position when videotaping and out of the line of sight when not in use. However, an eyesight ring may not be necessary when the RVH utilizes an extreme wide angle lens showing point of view of the user.

A four-wire electrical cable 18 is connected to the rear of the RVH and routed along and down the helmet with fasteners whereby the terminal end of the cable 18 extends about twelve inches below the lower edge of the helmet. The electrical cable 18 terminates in a four-pin connector 19 operative to be connected to the camera body pouch 14 to a specially manufactured extension cable 16 to be described hereinafter. The cable is operative to transmit 12 volts of power from a battery pack secured in the camera body pouch which substantially reduces the weight attached to the headgear.

In the above manner, the video images received by the remote video head 12 are delivered through the electrical cable 16 to the video camera C disposed in the camera body pouch 14.

Referring now to FIG. 5, the camera body pouch 14 is used to secure a standard and unmodified video camcorder C to the body of the user or an item being worn by the user such as a parachute harness. A large main compartment holds the video camera while a small compartment 52 on the right side contains a battery pack that supplies power to the RVH 12.

The camcorder C disposed in the camera body pouch 14 acts as the videotape transport and recording device. Although the camcorder C may be operated outside the body pouch 14 in a normal manner in its record mode, while it is in the pouch and connected to the RVH, it will be preset and operated in its videotape recorder (VTR) or video cassette recorder (VCR) mode. Several models of video cameras are suitable for use with the inventive video system 10, but they must include remote operation facilities, frequently referred to as “LANC”, in order to be used as intended with the inventive system 10.

The camera body pouch 14 is preferably formed of a high strength, durable, natural or synthetic fabric or animal skin. Most preferably, the pouch 14 is padded and made of nylon whereby the pouch 14 operates to protect the delicate and expensive video camera from the rigors of a high-action sport such as skydiving. In addition, the camera pouch 14 protects the camera from exposure to moisture in the form of rain or condensation which can cause electrical problems and shut down all of the camera functions for a period of time due to moisture intrusion.

Preferably, the camera body pouch 14 includes tie-down straps having quick connect fasteners 24 disposed at the terminal ends which mate with complementary fasteners at the ends of tie-down straps disposed on the user. Preferably, the tie-down straps are adjustable so the body pouch 14 can be secured snugly to the body of the user after connection.

The body pouch 14 includes a top flap 30 disposed with a conventional fastening means for closing the flap 30 over the camera C once disposed therein. Illustratively, the fastening means may be provided in the form of Velcro, snap fasteners, zippers and quick connect fasteners 24 as described above. For skydiving purposes the pouch is designed to be positioned in the stomach area below the ribs to avoid injury should the user accidentally fall on top of it at the end of a jump.

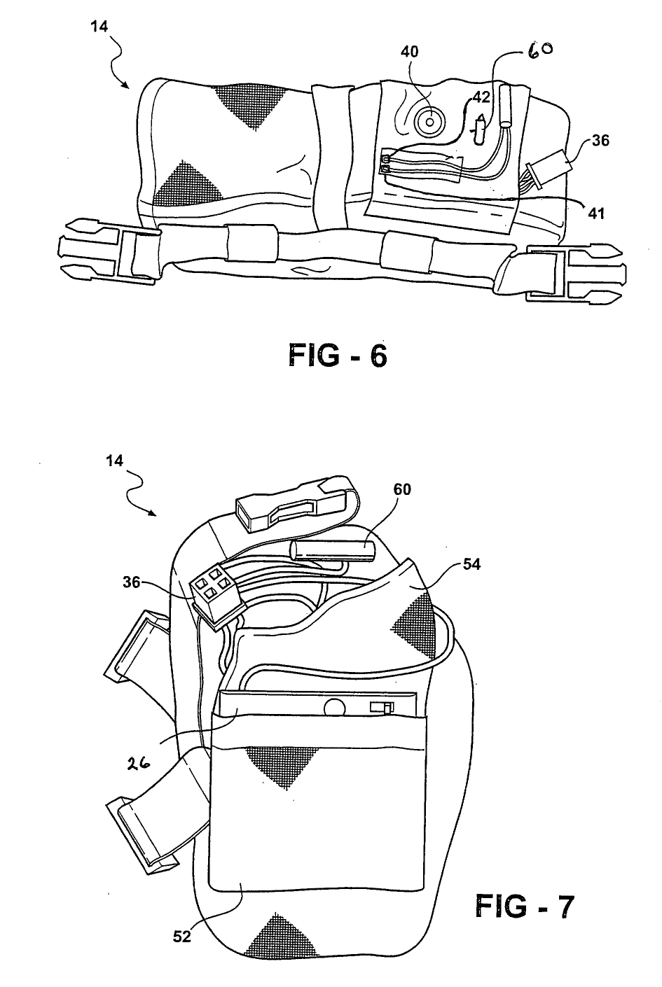

With reference to FIGS. 6 and 7, the body pouch 14 houses an RVH battery pack 26 in a specially designed battery compartment 52 as well as a plurality of switches, cables, jacks and indicator lights which operate and monitor the video camcorder disposed in the pouch and the RVH.

The RVH battery pack is electrically connected into the camera body pouch 14 system by a standard jack for easy removal from the pouch 14 or for switching battery packs. A cable in communication with the battery pack is routed to the top of the pouch and ends in a miniature light bulb or light emitting diode (LED) 41. The bulb 41 is preferably green to differentiate it from the other colored indicating lights. The illuminated green light indicates to the user that the power to the RVH 12 is “on”. If the light is not illuminated, it indicates that the power to the RVH is “off”.

As illustrated in FIG. 7, a special “line level” mini microphone 60 is electrically connected to the video camera audio/video jack for supplying live audio to the camera C in its recording mode at the same time the RVH 12 is supplying a live video signal. The mini microphone 60 has its own built-in amplifier and can be powered either by its own battery or the RVH power supply.

The video signal from the RVH 12 is transmitted through an RVH extension cable 16 (see FIG. 3) for connecting the RVH 12 to a complementary connector 36 disposed at the camera body pouch. From the connector 36 the video signal is communicated to the AV jack of the video camera C via a short video cable connected to the complementary connector 36.

The camera body pouch 14 also includes a pushbutton multi-function switch 40 built into the top of the body pouch 14 which has two cable extensions attached thereto. One cable terminates in a miniature multi-colored light bulb 42 or LED which is a visual indicator of the status of several camera functions such as standby (blue light), record (red light), or powering down (red and blue light). The multi-colored bulb 42 is positioned on top of the body pouch 14 next to the multi-function switch 40 for ease of visual inspection. Both bulbs are secured inside a clear plastic sleeve.

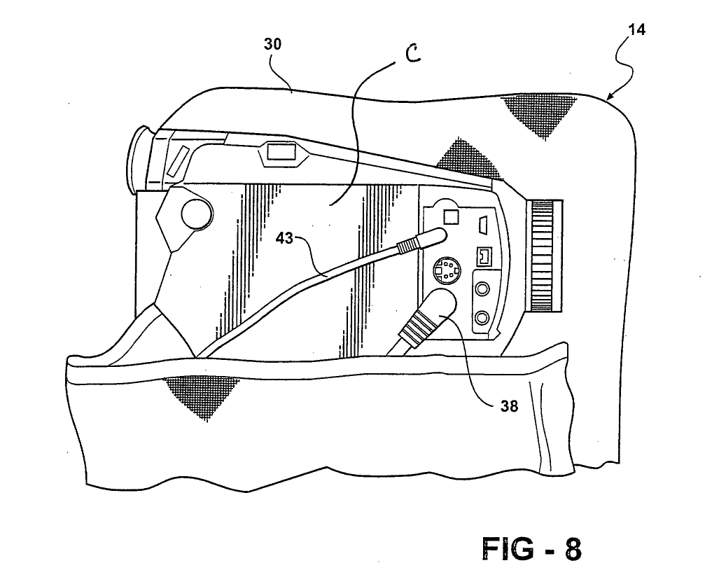

As shown in FIG. 8, the other cable 43 from switch 40 is routed into the interior of the camera body pouch 14 main compartment and terminates in a jack for connecting to,the remote control (LANC) port of the video camera C whereby the switch enables the user to operate the camera remotely while it is secure and protected inside the camera body pouch 14. As with the AV jack, this cable connector can be easily disconnected from the video camera so that the camera can be quickly removed from the body pouch 14 and utilized as a normal video camcorder. The multi-function switch 40 makes the use of the remote video head both easy and viable under the difficult environmental conditions of extreme sport videography.

The RVH extension cable 16 is a three-foot cable enclosing four wires that terminate in a four-pin connector which engages the complementary connector disposed at the camera body pouch 14. It is purposely longer than necessary so that the cable can be connected to the RVH before the helmet is placed on the head. This facilitates checking all the camera functions before use. The excess cable is then stored inside the user's jumpsuit in the case of skydiving before the filming begins. The two wires carry the battery power from the battery pack in the body pouch 14 to the RVH while the other two wires carry the video signal in the opposite direction from the RVH to the video camera in the body pouch 14.

In using the video system 10 while skydiving, as the plane takes off, the video camera C is handheld and used manually in the record mode to film the passengers in the aircraft. The camcorder is then switched from the record mode to the VCR/VTR mode and the AV and remote connectors inside the body pouch are plugged into the video camera C.

The multi-colored light on top of the body pouch 14 should indicate a blue light showing the camcorder C is powered up and on standby. The RVH extension cable 16 is connected to the RVH 12 disposed on the helmet and to the body pouch 14 which is attached to the front of the user's parachute harness. At the right side of the body pouch 14 the RVH battery switch is turned on and the indicator LED on top of the body pouch turns green. The camcorder C viewing screen is opened to see that there is a picture emanating from the RVH 12 which indicates that all functions and connections are operational.

Thereafter the multi-function switch 40 is held down until the multicolored light blinks blue and red. When the multi-function switch 40 is released, the multi-colored light turns off indicating the camera C is powered down and the picture on the camera viewing screen turns off. With the camcorder switch still in the VCR position, the viewing screen is closed and the camcorder is placed inside the body pouch 14 and the top flap 30 is closed. When the aircraft has reached jump altitude, the RVH power is turned on and the green light glows. The helmet is placed on the head and the chinstrap is secured. At any time during the jump run prior to exiting the aircraft, the multifunction switch 40 can be touched to power up the camcorder C in the pouch and the blue light glows indicating the camera is in standby mode. Just before the command is given to exit the aircraft, the multi-function switch is touched again and the blue light immediately changes to red indicating that the camera is recording.

The camera C is left on during freefall, but after the parachute is opened the camera can be turned to standby to conserve tape. Then at the end of the parachute descent the camera C can be turned on again with the touch of the multi-function switch 40 to record the videographer's landing. In this manner the freefalling videographer has now documented the entire skydiving events seamlessly using both the camcorder in a normal fashion for ground and aircraft scenes, as well as the remote video head for freefall and landing.

From the foregoing an inventive video system for use in the videography of extreme sports such as skydiving is provided. Having described the video system, however, it is appreciated that many modifications thereto may become apparent to one of skill in the art without deviation from the spirit of the invention as defined by the scope of the appended claims.

I claim:

1. A video apparatus for a user, said apparatus comprising:
a remote video head disposed on a head of the user;
a pouch operative to receive a video camera and to be selectably secured to the user; and
a cable connected between said remote video head and said video camera, said cable operative to transmit a video signal from said remote video head to said video camera for recording.

2. The video system of claim 1 wherein said pouch further comprises a battery compartment for receiving a battery.

3. The video system of claim 1 wherein said remote video head is mounted to headgear worn by the user.

4. The video system of claim 3 further comprising a universal mounting bracket for securing said miniature remote video head to the headgear.

5. The video system of claim 3 further comprising a Newton Ring eyesight disposed on the helmet and operative to assist the user in aiming the lens of the remote video head in a desired direction.

6. The video system of claim 3 wherein said remote video head is a color video camera.

7. The video system of claim 1 wherein said pouch includes a multi-function switch connected to the video camera, said switch operative to control the video camera.

8. The video system of claim 1 wherein said apparatus includes a first cable in communication with said remote video head and a second cable routed to a top portion of said camera body pouch, said second cable having an indicator light at its terminal end wherein said indicator light illuminates when the remote video head is powered on.

9. The video system of claim 1 wherein said multi-function switch is disposed adjacent a top portion of said pouch, said multi-function switch in communication with two cable extensions.

10. The video system of claim 9 wherein one of said extension cables connects to a multi-colored indicator light disposed on said top portion of said camera body pouch and the other extension cable connects to a remote control jack of the video camera.
